(19) United States
(12) Patent Application Publication
(10) Pub. No.: US 2008/0156996 A1
(43) Pub. Date: Jul. 3, 2008

(54) Indirect Method and Apparatus for Cooling a Silicon Drift Detector

(75) Inventors: Joseph A. Nicolosi, Bardonia, NY (US); Sun K. Park, Paramus, NJ (US); Leong Ying, Hoboken, NJ (US); Steven Cacioppo, Mahwah, NJ (US); Michael Solazzi, Hillsdale, NJ (US); Bob Westerdale, Hewitt, NJ (US)

Correspondence Address: THE WEBB LAW FIRM, P.C., 700 KOPPERS BUILDING, 436 SEVENTH AVENUE, PITTSBURGH, PA, 15219, US

(73) Assignee: AMETEK, INC., Paoli, PA (US)

(21) Appl. No.: 11/678,225

(22) Filed: Feb. 23, 2007

Related U.S. Application Data
(60) Provisional application No. 60/877,852, filed on Dec. 29, 2006.

(51) Int. Cl. G01T 1/24; F25B 9/02

(52) U.S. Cl. 250/370.15

(57) ABSTRACT

An apparatus for the indirect cooling of a silicon drift detector (SDD) includes an enclosure with a vacuum maintained therein, at least one SDD module that generates substantially no heat positioned within the enclosure, a cooling engine positioned remote from the SDD module within the enclosure for cooling the SDD module, whereby heat is generated by the cooling engine, a thermal conduction device comprising a first end thermally coupled to the cooling engine and a second end thermally coupled to the SDD module and a heat removal device thermally coupled to the cooling engine. The cooling engine indirectly cools the SDD module by transferring thermal energy through the thermal conduction device from the SDD module and the heat removal device dissipates the heat generated by the cooling engine to the environment surrounding the enclosure. A method for indirectly cooling a radiation detector is also provided.

### CROSS REFERENCE TO RELATED APPLICATIONS

This application claims the benefit of U.S. Provisional Patent Application No. 60/877,852 entitled “An Indirect Method and Apparatus for Cooling a Silicon Drift Detector” filed Dec. 29, 2006, which is hereby incorporated by reference in its entirety.

### BACKGROUND OF THE INVENTION

1. Field of the Invention

The present invention is related, in general, to silicon drift detectors (SDD). More specifically, the present invention is directed to a method and system for cooling an SDD.

2. Description of Related Art

In radiation detector systems, cooling of the radiation detector and input components of the amplification circuit generally reduces electronic noise and enhances spectroscopic performance of the system. Liquid nitrogen (LN₂) has traditionally been used for such cooling purposes.

U.S. Pat. No. 5,274,237 to Gallagher discloses a typical LN₂ or cryogenic cooling system for a radiation detector. With reference to FIG. 1, a cryogenic cooling system 1 of U.S. Pat. No. 5,274,237 includes a dewar 3 which contains liquid nitrogen coolant (not shown). The dewar 3 is secured to an assembly 5 via a coupling structure 7. The coupling structure 7 includes a support 9 containing an aluminum heat conductor 11 which thermally conductively couples the liquid nitrogen coolant in dewar 3 to a portion of the assembly 5 to be cooled. The assembly 5 includes a housing 13 secured to the support 9. The housing 13 comprises an elongated finger-like portion 15 extending from a body 17. The housing 13 has an elongated cavity 19. Secured within the cavity 19 is a cold finger assembly 21. A radiation detector assembly 23 is thermally conductively secured to the end of cold finger assembly 21. Conductive braided wire 25 flexibly attaches cold finger assembly 21 to the dewar 3. The cold finger assembly 21 conducts heat from radiation detector assembly 23 to the dewar 3.

However, such LN₂ or cryogenic cooling systems suffer from various drawbacks. For instance, a major weakness of LN₂ cooling is the necessity for a large dewar which takes up space. Also, using LN₂ is hazardous, inconvenient, and expensive. By way of example, severe bums can result from skin contact with LN₂. In addition, the LN₂ dewars must be refilled on a regular basis in order to maintain the detector at operating temperature.

Furthermore, radiation detectors are frequently mounted at locations that are not easily accessible, and refilling the LN₂ dewar is often an unsafe and uncomfortable operation, during which a user must carefully follow safety procedures or risk injury. The cost of purchasing, storing, and handling LN₂ over the lifetime of a radiation detector can be very high. Since LN₂ evaporates from both the detector dewar and the storage tank, waste cannot be prevented. Also, during the refilling process, significant amounts of LN₂ are typically lost due to evaporation and spillage. Thus, in addition to the expense of LN₂ consumed for cooling the detector, additional expenses are incurred because of LN₂ loss during dewar refilling and storage.

By way of example, about ten liters of LN₂ per week evaporate from a standard detector dewar, and about the same amount is lost during transfer and through evaporation from the storage tank. Therefore, a standard 160-liter storage tank lasts about eight weeks and must be refilled an average of 6.5 times per year. Hence, the annual cost of cooling an LN₂-based detector for operation is high due to constant replenishment of coolant.

As an alternative to liquid nitrogen cooling, several cooling systems employing various types of refrigeration cycles have been commercially introduced. For instance, mechanical gas cycle cryogenic coolers have been successfully used to cool radiation detectors down to temperatures as low as those obtainable using liquid nitrogen cooling systems. Mechanical coolers are convenient and relatively cost effective, and they avoid the handling problems associated with liquid nitrogen cooling.

U.S. Pat. No. 5,816,052 to Foote et al. discloses an apparatus for mechanically cooling a radiation detector. The layout for such an apparatus is illustrated in FIG. 2. A radiation detector system 27 includes a probe 29 having a solid-state radiation detector mounted within an outer tube near the tip 31 of the probe 29. The probe 29 also includes a heat conductive cold finger (not shown) enclosed within an outer tube thereof. The probe 29 extends from a sliding base unit 33 which is mounted for sliding back-and-forth movement on a mounting bracket 35, such that the probe 29 can be selectively advanced inwardly toward a target. A mechanical cryocooler unit 37 is mounted to the sliding base unit 33, and an extension 39 of the cold finger extends upwardly from the sliding base unit 33 into the mechanical cryocooler unit 37. Incoming outgoing gas lines 41 and 43, respectively, extend from a compressor unit 45 to the cryocooler unit 37. A vibration isolating unit 47 is mounted in the lines 41 and 43 to help minimize transmission of vibrations from the compressor 45 through the lines 41 and 43 to the cryocooler unit 37. In typical installations, the gas lines 41 and 43 may be several feet long so that the compressor unit 45 is situated well away from the radiation detector system 27.

U.S. Pat. No. 5,811,816 to Gallagher et al. discloses another type of mechanical cooling system for a radiation detector. The radiation detector system of this patent includes an evacuated envelope, a radiation detector on a cold fmger support in the evacuated space, a closed cycle gas cooling system to cool the cold fmger to provide cryogenic operation of the radiation detector, and a getter in the evacuated space to maintain an evacuated condition. The closed cycle gas cooling system includes a compressor, supply and return lines, an external mass damper and a counterflow heat exchanger. The compressor, supply and return lines, and the external mass damper are positioned outside of the evacuated envelope. Only the counterflow heat exchanger is positioned within the evacuated envelope. The cooling system of this patent also includes a variety of damping devices used to reduce vibration caused by the various components of the closed cycle gas cooling system.

While such systems have several advantages as discussed above, mechanical cryogenic refrigeration coolers also suffer from various limitations. In particular, mechanical coolers introduce vibration into the system, either from the compressor or from the heat exchanger connected to the proximal end of a cold fmger. This vibration from the cooler is transmitted to the detector cold finger and thence to the solid-state detector itself. The vibration changes the capacitance of the entire structure, thereby inducing electronic noise into the system which degrades the peak resolution that can be obtained with the system. Further, the vibration from the cooler can be transmitted to the electron microscope through the radiation detector system itself, which deteriorates the clarity and resolution in images of the specimens at higher magnifications, for example, above about 30,000 to 40,000 times magnification.

Accordingly, radiation detectors utilizing thermoelectric coolers (TECs) are now being frequently used in many applications. A TEC is a small heat pump that has no moving parts and can be used in various applications where space is limited and reliability is very important. The TEC operates using direct current by moving heat from one side of the module to the other with current flow and principles of thermodynamics. The theories behind the operation of TEC can be traced back to the early 1800's when Jean Peltier discovered that there is a heating or cooling effect when electric current passes through two dissimilar conductors.

An example of a radiation detector utilizing a TEC is disclosed in United States Patent Application Publication No. 2005/0285046 to Iwanczyk. With reference to FIG. 3, the radiation detector system of United States Patent Application Publication No. 2005/0285046 provides for the direct cooling of a radiation detector using a TEC. The radiation detector system includes a heat pipe 49, a TEC 51, a radiation detector 53 and front-end electronic components 55 mounted near an evaporator end of the heat pipe 49. The radiation detector 53 is mounted on, and is thermally coupled to the TEC 51. The TEC 51, the radiation detector 53 and the front-end electronic components 55 are placed inside a cap 57, which is mounted to a base plate 59, and held in a vacuum. The TEC 51 is thermally coupled to a first end of the heat pipe 49. The other end of the heat pipe 49 is thermally coupled to a condenser 61, which is thermally coupled to a heat sink 63 which dissipates heat energy into the surrounding environment. The radiation detector system also includes a fan 65 for dissipating heat to the surrounding environment to reduce a temperature gradient between the heat sink 63 and the surrounding environment.

Such a direct cooling system using a TEC also suffers from a variety of limitations. For instance, the TEC produces heat directly at the radiation detector chip. This heat must be transferred away from the radiation detector chip. Accordingly, the lowest possible temperature at the chip cannot be achieved and, consequently, optimal energy resolution cannot be achieved.

### SUMMARY OF THE INVENTION

Accordingly, a need exists for an apparatus and method for indirectly cooling a silicon drift detector (SDD) in a radiation detection system that allows for more efficient cooling of the SDD and the cooling of the SDD to lower temperatures. A further need exists for a radiation detection system where there is no source of heat at the detection end, and the radiation detector system generates substantially no heat.

The present invention is directed to an apparatus for the indirect cooling of a silicon drift detector (SDD). The apparatus includes an enclosure with a vacuum maintained therein, at least one silicon drift detector (SDD) module that generates substantially no heat positioned within the enclosure, a cooling engine positioned remote from the silicon drift detector (SDD) module within the enclosure for cooling the silicon drift detector (SDD) module, whereby heat is generated by the cooling engine, a thermal conduction device comprising a first end thermally coupled to the cooling engine and a second end thermally coupled to the silicon drift detector (SDD) module and a heat removal device thermally coupled to the cooling engine. The cooling engine indirectly cools the silicon drift detector (SDD) module by transferring thermal energy through the thermal conduction device from the silicon drift detector (SDD) module and the heat removal device dissipates the heat generated by the cooling engine to the environment surrounding the enclosure.

The SDD module may include an SDD and a first stage amplifier. The cooling engine may be a thermoelectric cooler (TEC), a mechanical cooling device, liquid nitrogen or any combination thereof. The thermal conduction device may be a metal conductor, a non-metal conductor, a fluid filled conductor or any combination thereof. The thermal conduction device may be a solid metal conductor constructed as a copper rod having a diameter between 0.32 cm (⅛″) and 1.27 cm (½″).

Desirably, the cooling engine may be configured to indirectly cool the SDD module by lowering the temperature of the thermal conduction device thereby causing the thermal conduction device to lower the temperature of the SDD module. The heat produced from the environment may be removed by the cooling engine. The cooling engine may indirectly cool the SDD module to a temperature below −30° C.

Desirably, the controlled environment is a vacuum. The heat removal device may include a heat sink, fan, fluid, or any combination of thereof. A fan may be positioned proximately to the heat removal for dissipating heat from the heat removal device to the environment surrounding the enclosure.

The present invention is further directed to an apparatus for cooling a silicon drift detector (SDD) module. The apparatus includes an enclosure with a controlled environment maintained therein, at least one SDD module positioned within the enclosure, a cooling engine that generates substantially no heat within the controlled environment, a thermal conduction device comprising a first end thermally coupled to the cooling engine and a second end thermally coupled to the SDD module and a heat removal device thermally coupled to the cooling engine. The cooling engine cools the SDD module through the thermal conduction device and the heat removal device dissipates the heat generated by the cooling engine to an environment surrounding the enclosure.

The SDD module may be windowless and may include an SDD and a first stage amplifier. The first stage amplifier may be positioned adjacent to the SDD of the SDD module in the enclosure.

The cooling engine may be controlled to maintain a target temperature. The cooling engine may be a thermoelectric cooler (TEC), a mechanical cooling device, liquid nitrogen or any combination thereof. The thermal conduction device may be a metal conductor, a non-metal conductor, a fluid filled conductor or any combination thereof. Desirably, the thermal conduction device may be a solid metal conductor constructed as a copper rod having a diameter between 0.32 cm (⅛″) and 1.27 cm (½″).

Desirably, the cooling engine may be configured to indirectly cool the SDD module by lowering the temperature of the thermal conduction device thereby causing the thermal conduction device to lower the temperature of the SDD module. The heat produced from the environment may be removed by the cooling engine. The cooling engine may indirectly cool the SDD module to a temperature below −30° C.

Desirably, the controlled environment is a vacuum. The heat removal device may include a heat sink, fan, fluid, or any combination of thereof. A fan may be positioned proximately to the heat removal for dissipating heat from the heat removal device to the environment surrounding the enclosure.

The present invention is further directed to a method of cooling at least one silicon drift detector (SDD) module. The method includes the steps of: positioning the SDD module within an enclosure that maintains a controlled environment, positioning a cooling engine remotely from the SDD module within the controlled environment in the enclosure, thermally coupling the SDD module to the cooling engine with a thermal conduction device, thermally coupling the cooling engine to a heat removal device, indirectly cooling the SDD module by transferring thermal energy through the thermal conduction device from the SDD module and dissipating the heat generated by the cooling engine to an environment surrounding the enclosure with the heat removal device. The SDD module produces substantially no heat. Parasitic heat produced by the environment may be transferred to the cooling engine.

The SDD module may include an SDD and a first stage amplifier. The cooling engine may be a thermoelectric cooler (TEC), a mechanical cooling device, liquid nitrogen or any combination thereof. The thermal conduction device may be a metal conductor, a non-metal conductor, a fluid filled conductor or any combination thereof. The controlled environment is desirably a vacuum.

In addition, the present invention is a thermal conduction device for use with an apparatus for the indirect cooling of a silicon drift detector (SDD) module. The thermal conduction device includes a first end thermally coupled to the SDD module, a second end thermally coupled to a cooling engine and an elongated body formed between the first end and the second end. The thermal conduction device lowers the temperature of the SDD module by transferring thermal energy from the SDD module.

The elongated body may be formed as a fluid filled conductor, a solid metal conductor, a solid non-metal conductor or any combination thereof. The solid metal conductor may be aluminum, copper, silver or any combination thereof. The solid non-metal conductor may be graphite that extracts heat predominately by electronic transfer. The solid non-metal conductor may be diamond, sapphire or any combination thereof. Such a solid non-metal conductor extracts heat predominately by phonon transfer.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. As used in the specification and the claims, the singular form of “a”, “an”, and “the” include plural referents unless the context clearly dictates otherwise.

### BRIEF DESCRIPTION OF THE DRAWINGS

FIG. 1 is a cross-sectional side view of a conventional prior art radiation detector system utilizing a LN₂ cooling technique;

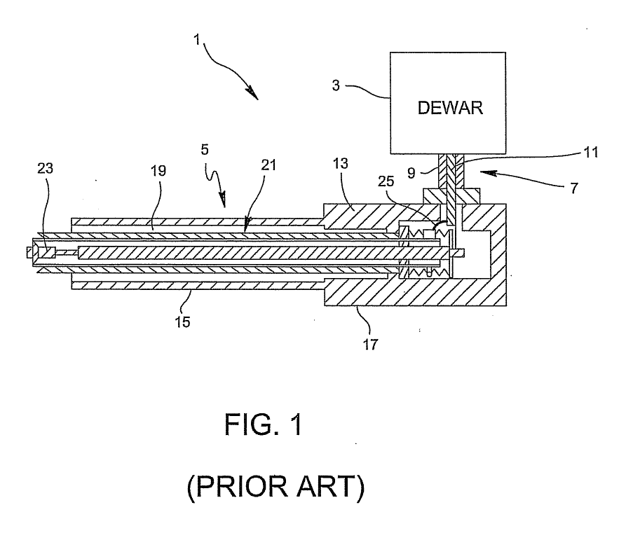

FIG. 2 is a perspective view of a conventional prior art radiation detector system utilizing a mechanical cooling technique;

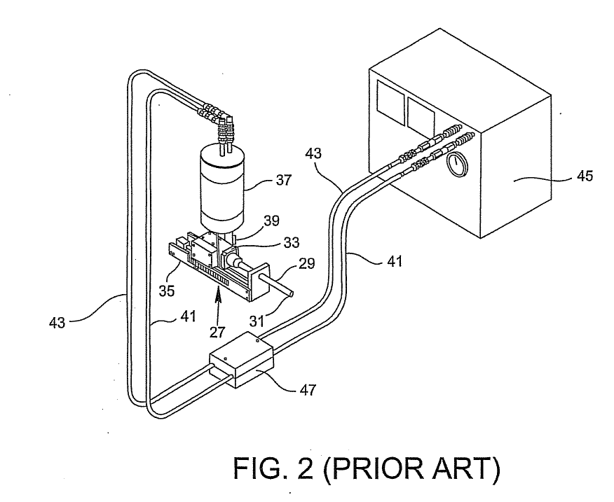

FIG. 3 is a partial cross-sectional side view of a conventional prior art radiation detector system utilizing a direct thermoelectric cooling technique;

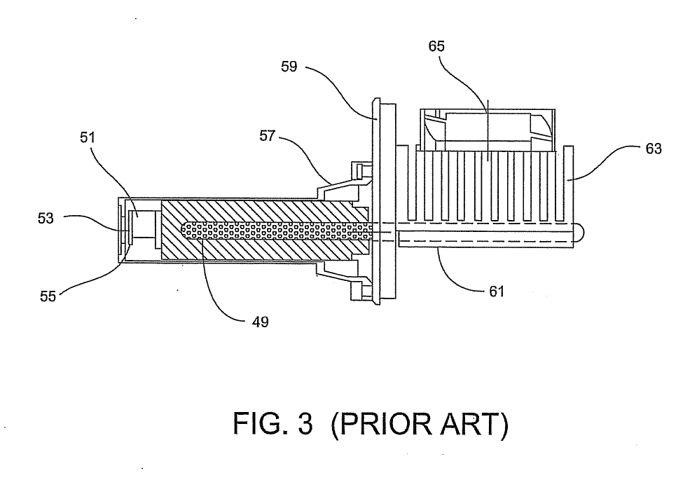

FIG. 4 is a perspective view of a radiation detector system utilizing an indirect cooling technique in accordance with the present invention;

FIG. 5 is another perspective view of the radiation detector system of FIG. 4;

FIG. 6 is a cross-sectional side view of the radiation detector system of FIG. 4 taken along the line 6-6; and

FIG. 7 is a flow-diagram of a method of cooling an SDD module in accordance with the present invention.

### DETAILED DESCRIPTION OF THE PRESENT INVENTION

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

The present invention is directed to an apparatus and method for indirectly cooling an SDD module in a radiation detection system. The apparatus and method of the present invention allows for more efficient cooling of the SDD module and the cooling of the SDD module to lower temperatures by eliminating the need to remove heat generated by a cooling engine positioned near the SDD module or packaged within the module. The lower temperatures achieved by the apparatus and method of the present invention minimize leakage current and improve energy resolution.

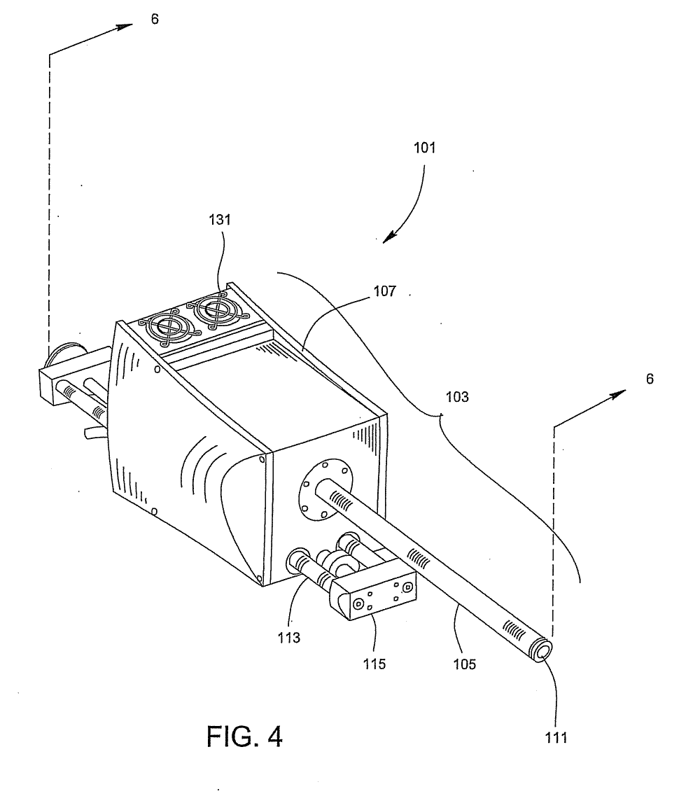

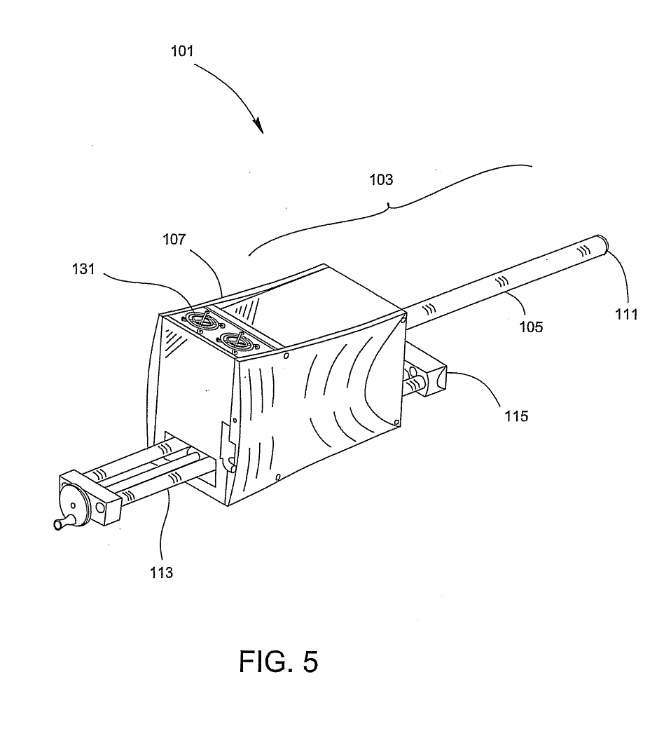

With reference to FIGS. 4-6, a radiation detection system, denoted generally by reference numeral 101, includes an enclosure 103 with a front end portion including a probe 105 and a base unit 107. Probe 105 includes a radiation detector module 109 mounted near the tip 111 thereof. Base unit 107 is mounted on a bracket 113 for sliding back and forth movement such that probe 105 can be selectively advanced inwardly toward a target. A mounting structure 115 is provided at an end of bracket 113 to allow radiation detector system 101 to be mounted to a wall (not shown) or other suitable structure.

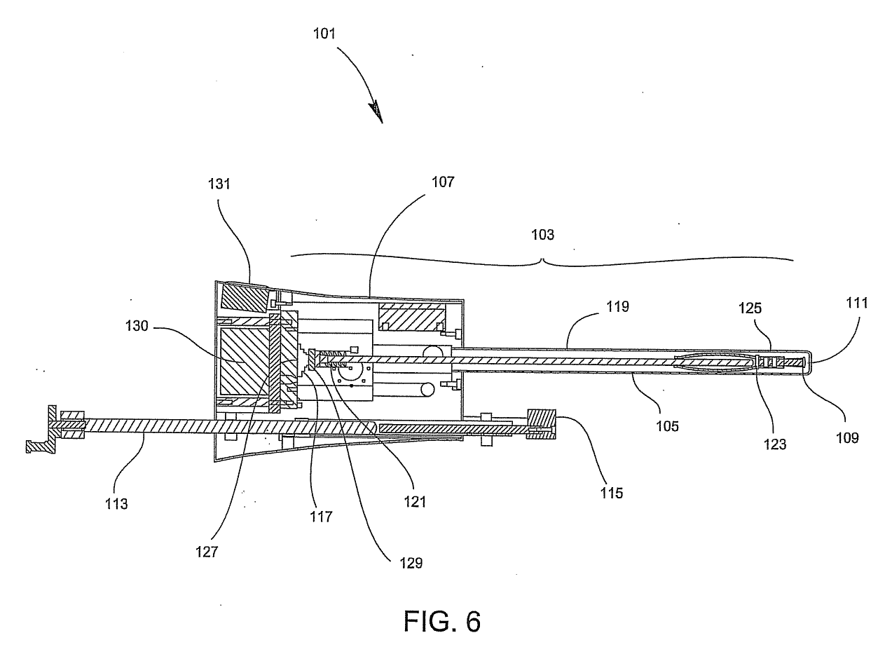

With reference to FIG. 6 specifically, radiation detector module 109 is positioned within enclosure 103 near the tip 111 of probe 105 and a cooling engine 117 is positioned remote from radiation detector module 109 within base unit 107 in a back-end portion of enclosure 103 for cooling radiation detector module 109. A thermal conduction device 119 with a first end 121 thermally coupled to cooling engine 117 and a second end 123 thermally coupled to radiation detector module 109 is positioned within probe 105. Such a configuration allows for the cooling of radiation detector module 109 without heat generation near the radiation detector module in the front-end portion of enclosure 103. Radiation detector module 109, cooling engine 117 and thermal conduction device 119 are each positioned within enclosure 103, which maintains a controlled environment therein. In particular, the interior environment defined within enclosure 103 represents a controlled environment of radiation detector system 101. The interior environment defined by enclosure 103 is preferably a clean environment which is evacuated such that the controlled environment may be, without limitation, a vacuum. The vacuum may be created and maintained inside enclosure 103 by an external pump (not shown). The external pump may be, without limitation, an ion pump or a getter pump. For example, and without limitation, the pressure inside enclosure 103 may be maintained between 10⁻³ to 10⁻⁷ torr while the vacuum is being maintained.

Radiation detector module 109 of the present invention includes a radiation detector and a first stage amplifier. Radiation detector module 109 is desirably a silicon drift detector (SDD) module with an SDD as the radiation detector. A basic SDD comprises a volume of fully depleted silicon in which electric fields vertical and parallel to the surface are driving signal electrons generated by the incoming x-ray radiation towards a small sized collecting anode. The energy resolution of the SDD is determined by the leakage current of the silicon and the value of the read out capacitance. The leakage current of the SDD is kept small by manufacturing the SDD with high resistivity silicon and an ultrapure fabrication process. Further, the read out capacitance of the SDD is small compared to other devices because the size of the anode is independent of the detector area. The SDD is preferable for use as the radiation detector of radiation detector module 109 because the SDD generates substantially no heat. While the present invention has been described above as including a radiation detector module 109 with a single radiation detector, this is not to be construed as limiting the invention, as radiation detector module 109 may include multiple radiation detectors in the form of an array of detectors may be utilized.

In many radiation detection applications, radiation detector systems suffer from low energy X-ray attenuation. The present invention is capable of minimizing low energy X-ray attenuation. Since the SDD which forms radiation detector module 109 generates substantially no heat, it may operate windowless in a vacuum. The removal of a window from the device minimizes low energy X-ray attenuation.

The radiation detector of radiation detector module 109, however, is not limited to an SDD. The radiation detector of radiation detector module 109, by way of further example, may be a detector having a different silicon structure such as low leakage current p-i-n. The radiation detector of radiation detector module 109 may also be a high resistivity compound semiconductor detector such as, for example, an HgI₂, CdTe or CdZnTe detector, which allows for construction of high energy resolution, spectroscopy systems. Further, the radiation detector may be based on SiLi structure or any other suitable radiation detector structure for spectroscopic or other applications.

Front-end electronic components 125 may be positioned adjacent to radiation detector 109 at tip 111 of probe 105 within enclosure 103. Front-end electronic components may include, but are not limited to readout electronics, amplifying circuitry, and the like, which are typically used for receiving and processing signals generated by radiation detector 109. Front-end electronic components 125 may also include a FET, a feedback capacitor or any other suitable feedback mechanism, which may provide the temperature data at radiation detector 109 to an external controller (not shown). In other embodiments, front-end electronic components 125 may also include a thermistor or the like, which may provide the temperature data at radiation detector module 109 to the external controller (not shown) for controlling/maintaining temperature of radiation detector module 109 during normal operations.

Thermal conduction device 119 may be any suitable, elongated device for the conduction of thermal energy to radiation detector module 109 including, but not limited to, a solid metal conductor, such as copper; a solid non-metal conductor, such as graphite, that extracts heat predominantly by electronic transfer; a solid non-metal conductor, such as diamonds or sapphire, that extracts heat predominately by phonon transfer; a fluid filled conductor; or a hybrid of any of the previously mentioned devices. It is also contemplated that a heat pipe may be used. Desirably, thermal conduction device 119 is a solid metal conductor formed as an elongated copper rod. The copper rod has a first end thermally coupled to radiation detector module 109, a second end thermally coupled to cooling engine 117 and an elongated body formed between the first end and the second end. The elongated body of the copper rod has a diameter of between about 0.32 cm (⅛″) and about 1.27 cm (½″) and, desirably, a diameter of about 0.64 cm (¼″). The present invention can utilize a copper rod having such small diameters because no heat is generated at radiation detection module 109. The use of such a copper rod is both less expensive and more efficient than prior art methods that utilize heat pipes. Furthermore, prior art cooling methods that place a cooling engine adjacent to the radiation module would not be able to use a copper rod having diameters small enough to be practical for use as the thermal conduction device with certain radiation detectors such as SDD'S, and would instead require the use of a copper rod having a much larger diameter (i.e., 1.90 cm (¾″)) which is impractical.

Cooling engine 117 may be any suitable cooling engine methodology such as, without limitation, a thermoelectric cooler (TEC), a mechanical cooling device, liquid nitrogen, etc. Cooling engine 117 is desirably a thermoelectric cooler (TEC). The TEC, for example, may be a PE4-106-14-10C available from Supercool AB, Box 27, 401 20 Gothenburg, Sweden.

A TEC uses the Peltier effect to create a heat flux between the junction of two different types of materials. The Peltier effect, which was observed by Jean Peltier in 1834, occurs when a current is passed through two dissimilar metals or semiconductors (i.e., n-type and p-type) that are connected to each other at two junctions. The current drives a transfer of heat from one junction to the other: one junction cools off while the other heats up. Accordingly, a TEC will have a hot side 127 and a cold side 129.

A typical single stage TEC includes two ceramic plates with p-type and n-type semiconductor material (i.e., bismuth telluride) between the plates. The elements of the semiconductor material are connected electrically in series and thermally in parallel. When a positive voltage is applied to the n-type thermo-element, electrons pass from the p-type thermo-element to the n-type thermo-element and cold side temperature decreases as heat is absorbed. The heat absorption (cooling) is proportional to the current and the number of semiconductor element pairs. The heat is transferred to the hot side of the cooler, where it is dissipated into a heat sink and/or the surrounding environment.

The cold side 129 of the TEC is thermally coupled to first end 121 of thermal conduction device 119, while the hot side 127 of the TEC is thermally coupled to a heat removal device 130 in the form of a heat sink or liquid cooled system. The heat sink 130 may be made of metal such as copper or aluminum. Radiation detector system 101 may further include a fan 131 for dissipating heat to the surrounding environment to reduce a temperature gradient between the heat sink 130 and the surrounding environment.

In operation, cooling engine 117 is powered and produces cooling energy at cool side 129 and heat at hot side 127. Cooling engine 117 thereby indirectly cools radiation detector 109 by transferring the cooling energy from its cool side 129 through thermal conduction device 119 to radiation detector module 109, thereby allowing thermal energy to be extracted from the radiation detector module 109. The heat generated at hot side 127 of cooling engine 117 is dissipated by heat removal device 130 and fan 131 to an environment surrounding the enclosure.

Since the radiation detector module 109 does not generate heat, no heat is generated at the front-end portion of the controlled environment in probe 105 of enclosure 103. This minimizes the heat transfer requirements of thermal conduction device 119, thereby allowing radiation detector module 109 to be cooled more efficiently and to lower temperatures than prior art cooling methods by eliminating the need to remove heat generated by cooling engine 117. The present invention can achieve temperatures of about −80° C. at radiation detector 109. Temperatures of this magnitude minimize leakage current and improve energy resolution of radiation detector module 109. Furthermore, the configuration of radiation system 101 reduces electrical interference by positioning cooling engine 117 within the back-end portion of enclosure 103 remote from radiation detector module 109. However, even though the radiation detector module 109 does not generate heat, a small amount of residual thermal energy is produced at radiation detector module 109. This residual thermal energy is produced by the environment surrounding enclosure 103, the device that generates the vacuum within enclosure 103, support structures or any combination thereof. Accordingly, thermal conduction device 119 extracts the residual thermal energy from the radiation detector module 109.

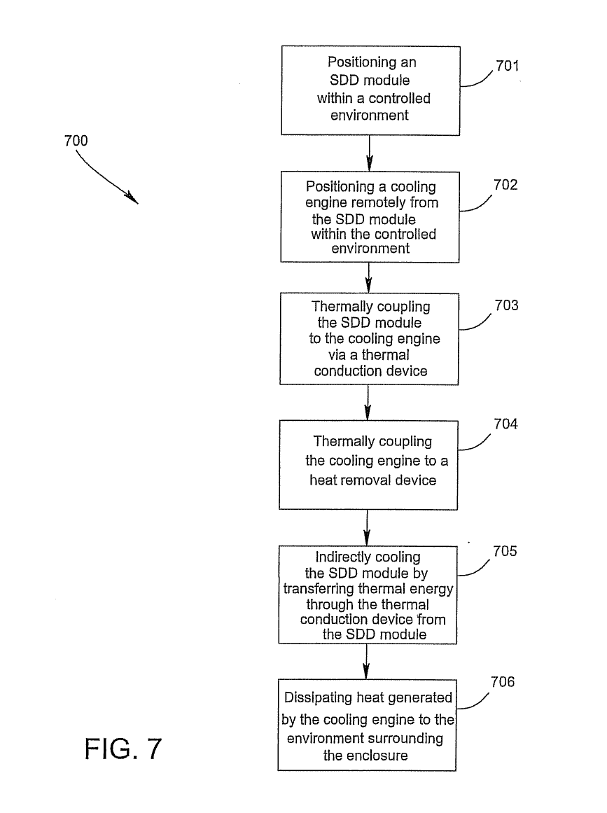

With reference to FIG. 7, the present invention is also a method, generally denoted by reference numeral 700, of cooling an SDD module. The method begins at step 701 by positioning SDD module 109 within the probe 105 of an enclosure 103 that maintains a controlled environment. Next, at step 702, a cooling engine 117 is positioned remotely from SDD module 109 within the controlled environment in a base unit 107 of enclosure 103. Then, at step 703, SDD module 109 is thermally coupled to cooling engine 117 with a thermal conduction device 119. At step 704, cooling engine 117 is thermally coupled to a heat removal device 130. Then, at step 705, SDD module 109 is indirectly cooled by transferring thermal energy through thermal conduction device 119 from SDD module 109. Finally, heat generated by cooling engine 117 is dissipated to an environment surrounding enclosure 103 by heat removal device 130 at step 706.

### COMPARATIVE EXAMPLES

The following examples provide compare the present invention to prior art devices. The examples are intended to be illustrative only and are not intended to limit the scope of the invention.

In prior art methods of cooling a radiation detector, such as United States Patent Application Publication No. 2005/0285046 to Iwanczyk et al. discussed hereinabove, the SDD module includes an SDD and a FET packaged with a TEC. Such an SDD module dissipates approximately 5 W of heat. This generation of heat needs to be transferred out of the system to maintain cold temperatures for the SDD module to function properly.

Using the standard thermal equation:

$$Q = \frac{AkT}{L} \qquad ( Equation 1 )$$

Where Q=Power, A=Area, k=Thermal Conductivity, T=Temperature Gradient and L=Length of the Thermal Conduction Device.

The target temperature to reach at the SDD module is about −80° C. and the length of the thermal conduction device should be about 0.30 m (12 inches). If a Oxygen Free High Conductivity copper cold finger having a diameter of 1.90 cm (¾″) and a length of 0.30 m (12 inches), then the values are as follows: Q=5 watts, A=2.85×10⁻⁴ m², L=0.30 m and k=400 W/mK. Therefore, the temperature gradient across the copper cold finger:

$$T = \frac{QL}{Ak} = \frac{( 5 ) ( 0.30 )}{( 2.85 \times {10}^{- 4} ) ( 400 )} = {13.4}^{°} C \qquad ( Equation 2 )$$

Accordingly, in order to remove the 5 W of heat generation from the SDD module of the prior art device across the length of the copper cold finger, a second TEC positioned at the opposite end of the copper cold finger from the SDD module would be required. Commercially available TEC's can achieve at most a 120° C. temperature difference between the cold side and hot side. If the hot side of the second TEC is allowed to reach 40° C., then the cold side will stabilize at around −80° C. However, with a 13.4° C. temperature gradient across the copper cold finger, the SDD module would stabilize at approximately −66.6° C. This means that the diameter of the copper cold finger would need to be even larger than 1.90 cm (¾″) to further decrease the temperature gradient necessary to get closer to the desired operating temperature of −80° C. The use of a copper cold finger with such a diameter is both costly and impractical. Furthermore, the use of a single TEC capable of extracting 5 W of heat dissipates over 200 W of heat on the hot side. This could lead to other thermal management issues.

On the other hand, the present invention generates substantially no heat at radiation detector module 109 and cooling engine 117 generates substantially no heat within the controlled environment. However, a small amount of residual heat is generated at radiation detector module 109 from the environment surrounding enclosure 103, devices that produce a vacuum within enclosure 103 and several other sources. A conservative estimate of the residual heat at radiation detector module 109 is 0.5 W. Keeping the other variables in Equation 2 above constant, the temperature gradient across the copper cold finger drops to about 1.3° C. This allows for the use of a copper cold finger in the system of the present invention with a smaller diameter (i.e., 0.64 cm (¼″)) than the cold fingers utilized in prior art configurations, as well as other thermal conduction devices such as non-metal solid thermal conductors. Furthermore, the use of an additional TEC is unnecessary.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements. Furthermore, it is to be understood that the present invention contemplates that, to the extent possible, one or more features of any embodiment can be combined with one or more features of any other embodiment.

The invention claimed is:

1. An apparatus for the indirect cooling of a silicon drift detector (SDD) comprising:
an enclosure with a vacuum maintained therein;
at least one silicon drift detector (SDD) module that generates substantially no heat positioned within the enclosure;
a cooling engine positioned remote from the silicon drift detector (SDD) module within the enclosure for cooling the silicon drift detector (SDD) module, whereby heat is generated by the cooling engine;
a thermal conduction device comprising a first end thermally coupled to the cooling engine and a second end thermally coupled to the silicon drift detector (SDD) module; and
a heat removal device thermally coupled to the cooling engine,
wherein the cooling engine indirectly cools the silicon drift detector (SDD) module by transferring thermal energy through the thermal conduction device from the silicon drift detector (SDD) module and the heat removal device dissipates the heat generated by the cooling engine to the environment surrounding the enclosure.

2. The apparatus of claim 1, wherein the SDD module comprises an SDD and a first stage amplifier.

3. The apparatus of claim 1, wherein the cooling engine is a thermoelectric cooler (TEC), a mechanical cooling device, liquid nitrogen or any combination thereof.

4. The apparatus of claim 1, wherein the thermal conduction device is a metal conductor, a non-metal conductor, a fluid filled conductor or any combination thereof.

5. The apparatus of claim 1, wherein the thermal conduction device is a solid metal conductor constructed as a copper rod having a diameter between 0.32 cm (⅛″) and 1.27 cm (½″).

6. The apparatus of claim 1, wherein the cooling engine indirectly cools the SDD module by lowering the temperature of the thermal conduction device thereby causing the thermal conduction device to lower the temperature of the SDD module.

7. The apparatus of claim 6, wherein the heat produced from the environment is removed by the cooling engine.

8. The apparatus of claim 1, wherein the cooling engine indirectly cools the SDD module to a temperature below −30° C.

9. The apparatus of claim 1, wherein the controlled environment is a vacuum.

10. The apparatus of claim 1, wherein the heat removal device comprises a heat sink, fan, fluid, or any combination of thereof.

11. The apparatus of claim 1, further comprising a fan positioned proximately to the heat removal for dissipating heat from the heat removal device to the environment surrounding the enclosure.

12. An apparatus for cooling a silicon drift detector (SDD) module comprising:
a) an enclosure with a controlled environment maintained therein;
b) at least one SDD module positioned within the enclosure;
c) a cooling engine that generates substantially no heat within the controlled environment;
d) a thermal conduction device comprising a first end thermally coupled to the cooling engine and a second end thermally coupled to the SDD module; and
e) a heat removal device thermally coupled to the cooling engine,
wherein the cooling engine cools the SDD module through the thermal conduction device and the heat removal device dissipates the heat generated by the cooling engine to an environment surrounding the enclosure.

13. The apparatus of claim 12, wherein the SDD module is windowless.

14. The apparatus of claim 12, wherein the SDD module comprises an SDD and a first stage amplifier.

15. The apparatus of claim 14, wherein the first stage amplifier is positioned adjacent to the SDD of the SDD module in the enclosure.

16. The apparatus of claim 12, wherein the cooling engine is controlled to maintain a target temperature.

17. The apparatus of claim 12, wherein the cooling engine is a thermoelectric cooler (TEC), a mechanical cooling device, liquid nitrogen or any combination thereof.

18. The apparatus of claim 12, wherein the thermal conduction device is a metal conductor, a non-metal conductor, a fluid filled conductor or any combination thereof.

19. The apparatus of claim 12, wherein the thermal conduction device is a solid metal conductor constructed as a copper rod having a diameter between 0.32 cm (⅛″) and 1.27 cm (½″).

20. The apparatus of claim 12, wherein the cooling engine indirectly cools the SDD module by lowering the temperature of the thermal conduction device thereby causing the thermal conduction device to lower the temperature of the SDD module.

21. The apparatus of claim 20, wherein the heat produced from the environment is removed by the cooling engine.

22. The apparatus of claim 12, wherein the cooling engine indirectly cools the SDD module to a temperature below −30° C.

23. The apparatus of claim 12, wherein the controlled environment is a vacuum.

24. The apparatus of claim 12, wherein the heat removal device comprises a heat sink, fan, fluid, or any combination of thereof.

25. The apparatus of claim 12, further comprising a fan positioned proximately to the heat removal device for dissipating heat from the heat removal device to the environment surrounding the enclosure.

26. A method of cooling at least one silicon drift detector (SDD) module comprising the steps of:
positioning the SDD module within an enclosure that maintains a controlled environment;
positioning a cooling engine remotely from the SDD module within the controlled environment in the enclosure;
thermally coupling the SDD module to the cooling engine with a thermal conduction device;
thermally coupling the cooling engine to a heat removal device;
indirectly cooling the SDD module by transferring thermal energy through the thermal conduction device from the SDD module; and
dissipating the heat generated by the cooling engine to an environment surrounding the enclosure with the heat removal device.

27. The method of claim 26, wherein the SDD module produces substantially no heat.

28. The method of claim 27, wherein parasitic heat produced by the environment is transferred to the cooling engine.

29. The method of claim 26, wherein the SDD module comprises an SDD and a first stage amplifier.

30. The method of claim 26, wherein the cooling engine is a thermoelectric cooler (TEC), a mechanical cooling device, liquid nitrogen or any combination thereof.

31. The method of claim 26, wherein the thermal conduction device is a metal conductor, a non-metal conductor, a fluid filled conductor or any combination thereof.

32. The method of claim 26, wherein the controlled environment is a vacuum.

33. A thermal conduction device for use with an apparatus for the indirect cooling of a silicon drift detector (SDD) module comprising:
a first end thermally coupled to the SDD module;
a second end thermally coupled to a cooling engine; and
an elongated body formed between the first end and the second end,
wherein the thermal conduction device lowers the temperature of the SDD module by transferring thermal energy from the SDD module.

34. The thermal conduction device of claim 33, wherein the elongated body is formed as a fluid filled conductor, a solid metal conductor, a solid non-metal conductor or any combination thereof,

35. The thermal conduction device of claim 34, wherein the elongated body is formed as a solid metal conductor, and the solid metal conductor is aluminum, copper, silver or any combination thereof.

36. The thermal conduction device of claim 34, wherein the elongated body is formed as a solid non-metal conductor, and the solid non-metal conductor extracts heat predominately by electronic transfer.

37. The thermal conduction device of claim 36, wherein the solid non-metal conductor is graphite.

38. The thermal conduction device of claim 34, wherein the elongated body is formed as a solid non-metal conductor, and the solid non-metal conductor extracts heat predominately by phonon transfer.

39. The thermal conduction device of claim 38, wherein the solid non-metal conductor is diamond, sapphire or any combination thereof.
